(19) United States
(12) Patent Application Publication
(10) Pub. No.: US 2006/0010033 A1
(43) Pub. Date: Jan. 12, 2006

(54) Reward programme points exchange

(76) Inventor: Graham Wayne Thomas, Randwick (AU)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/526,819

(22) PCT Filed: Sep. 8, 2003
(86) PCT No.: PCT/AU03/01170

§ 371 Date: Mar. 3, 2005

(30) Foreign Application Priority Data
Sep. 6, 2002 (AU) 2002951289

(51) Int. Cl. G06Q 99/00

(52) U.S. Cl. 705/14

(57) ABSTRACT

An “exchange” intermediates transactions involving reward points between reward programme participants providers and reward programme providers. Such an exchange may, for example, transact buying, selling or transferring points from, to, or between reward programme participants. The exchange offers to buy reward points from reward programme participants at a discounted value, and sell points to the reward programme provider at a cost value or to reward programme participants at a premium.

### FIELD OF THE INVENTION

The present invention relates generally to reward programmes, and relates more particularly to the trading of reward points.

### BACKGROUND

Reward programmes are intended to foster consumer loyalty, and can take many forms. Most reward programmes, however, operate to reward retail consumers with “rewards”—usually non-cash or like offers—following demonstrated consumer loyalty or recurring consumer activity. As a simple example, a cafe may provide every fifth cup of coffee free of charge. The consumer is thus encouraged to buy their morning coffee at the cafe each is weekday morning so that their Friday morning coffee will be free.

Larger businesses such as banks or airlines usually have more sophisticated reward programmes, through the principle is essentially the same. Typically, reward points are accumulated through the purchase of good or services with the programme provider or selected businesses. Reward points can be redeemed for available rewards, usually consumer goods, airline travel and the like, once sufficient points are accumulated.

One view held amongst consumers at large is that reward programmes are not of significant benefit. This view is perhaps attributable to a perceived lack of flexibility relating to the terms and conditions of many reward programmes. Various factors reduce the perceived value of reward programmes, such as a limited selection of rewards, restrictions concerning the redemption of points for rewards, the inconvenience of redeeming points for rewards, the length of time required to achieve rewards, or even the possible loss of reward points through financial failure of the programme provider.

A favoured redemption option for participants in reward programmes is travel, usually in the form of air fares. Air travel is also, however, the most expensive reward option for the reward programme provider. Further, reward point air travel is typically fraught with frustration, inconvenience and disappointment for programme participants. Airlines use reward point redemption to manage their load factors, which tends to make seats available at off-peak times and dates that do not match with typical travel schedules. Further, popular routes require booking many months in advance, which can be inconvenient if unforseen circumstances necessitate changes to travel plans. Extra expense or forfeiture of the reward points can result.

Reward programmes stipulate terms and conditions, particularly in relation to redemption of reward points. Terms and conditions can be quite involved, and usually involve clauses relating to non-transferability of points between participants. As an example, non-transferability conditions prohibit the possibility of family members consolidating their points to claim rewards. Also, reward points, under many programmes, “expire” if not redeemed within a certain time period.

The limited transferability of reward points, and their possible expiry, both serve to limit the rate at which points are redeemed. In many cases, participants leave a programme, and the accumulated points are simply cancelled without ever being redeemed. Despite such restrictions, reward programme providers find that their long-term “redemption” rates are around 80%.

Accumulated reward points, eligible for redemption but not yet redeemed, represent a significant non-current contingent liability for programme providers. As an example, the accumulated points liability of credit card reward programmes is estimated to be growing in the vicinity of AU$750 million per annum in Australia, and to a total sum of over US$500 billion in the United States of America.

A dilemma for reward programme providers is that their programmes create an expectation of continuity amongst participants: participants expect that their participation in the reward programme will be honoured. Reward programme providers meanwhile face pressure to reduce the cost of providing reward programmes due to competitive pressures. The expectation of programme continuity thwarts restructuring of rewards programmes. Significant changes to reward programmes undermines participants' confidence in the programme and, more seriously, can reduce the reward programme provider's brand integrity.

A need clearly exists, in view of these and other observations, for an improved manner of administering reward programmes.

### SUMMARY

An intermediary or “exchange” that trades in reward points improves the utility of reward programmes for reward programme participants and reward programme providers. Such an exchange acts as an intermediary between reward programme participants and reward programme providers to facilitate trading in reward points by either buying, selling or transferring points from, to, or between participants. Points can be redeemed from the exchange through provision of an offered reward. Transactions can also involve a combination of such transactions. An exchange may operate independently of reward programme providers, or in alliance with a specific reward programme provider.

Reward programme participants often have an incentive to purchase points at a premium to their notional value, to supplement their existing points that have been accumulated through previous transactions. Reward programme participants may in many cases wish to increase their accumulated points by purchasing such points, rather than simply accumulating further points by making purchases through the reward programme. Reward programme participants, in this way, can reach points “milestones”, at which a desired reward can be redeemed, by purchase of such points through an intermediating entity.

Reward programme providers have a clear interest in suppressing redemption rates, real or effective, as a reduced redemption rate lowers the cost of operating the reward programme. Marginal increases in redemption rates can, however, be offset by reward programme providers purchasing additional points at a discounted rate.

As an example, if a reward programme provider can buy points at a discount to their notional value, and also at a discount to the price at which such points can be sourced from alternative providers (that is, wholesale rates at which the provider is charged), a margin exists for reward programme providers.

Reward programme providers can reduce their contingent liabilities associated with redemption of reward points by participants. Conversely, participants can more flexibly use and redeem their reward points, encouraging further participation in the reward programme.

### DESCRIPTION OF DRAWINGS

FIG. 1 is a schematic representation of entities involved in transactions involving reward points conducted via an intermediary between reward programme participants and a reward programme providers.

FIG. 2 is a flowchart representing steps involved in such transactions conducted by the intermediary.

FIG. 3 is a schematic representation of a transaction of selling reward points to the intermediary.

FIG. 4 is a schematic representation of a transaction of buying reward points from the intermediary.

FIG. 5 is a schematic representation of a transaction of transferring reward points from one reward programme provider to another reward programme provider.

FIG. 6 is a schematic representation of a transaction of consolidating reward points from different reward programme providers and redeeming the consolidated points for a reward.

FIG. 7 is a schematic representation of a system architecture supporting intermediated transactions involving reward points.

FIG. 8 is a schematic representation of a computer system of a type suitable for use in the system architecture of FIG. 7.

### DETAILED DESCRIPTION

Participating Entities

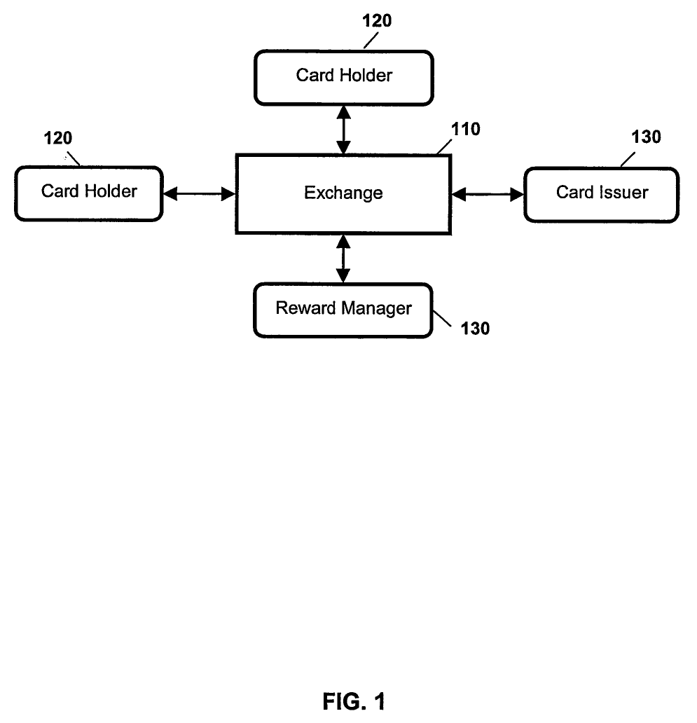

FIG. 1 schematically represents entities involved in the transaction procedures described herein. For convenience, the entity that intermediates transactions involving reward programme participants and reward programme providers is referred to herein simply as an “Exchange” 110. Such transactions involve the exchange of reward points that are recognized in accordance with reward programmes, as described herein. The reward programme participants are described herein as Card Holders 120, and the reward programme providers are described herein as Card Issuers 130.

Exchange 110 is able to communicate with both Card Holders 120 and Card Issuers 130, and also a Reward Manager 140. The Reward Programme is a contractual arrangement between Card Issuers 130 and their respective Card Holders 120. Card Issuers 130 make arrangements to support their contractual obligations to Card Holders 120 under the Reward Programme, often via a Reward Manager 140. As described herein, the Exchange 110 makes similar arrangements, and can rely upon a Reward Manager 140.

The Exchange 110 described herein is independent of Card Issuers 130, and Reward Managers 140. The Exchange 110 does not replace current service providers or Reward Programmes, but operates as an adjunct to existing services. The participation of Card Issuers 130 and Card Holders 120 is a matter of choice for the Card Issuer 130 and the Card Holder 120. The Exchange 110 provides for the buying, selling, trading and redemption of reward points, and effectively offers the Card Holder 120 more flexible use of their reward points than may be available with the Card Issuer 130.

Operational Background

Card Issuers 130 charge an annual fee for Card Holders 120 to become members of their reward programme. Points are awarded at the notional value of about one cent for every dollar spent on their credit card. There are variations to this theme, with some Card Issuers 130 awarding 10 points per dollar spent, but with the ten points still having the notional value of about one cent. From time to time, promotions are run with double points, bonus points, and so on. Some Card Issuers 130 award double points on overseas purchases.

Card Issuers 130 generally outsource responsibility for the operation of the Reward Programme by contracting Reward Managers 140 to run their Reward Programme. The Card Issuer 130 or Reward Manager 140 sometimes pays external service providers the value or partial value of the points before the points are redeemed. An example is members of reward programmes that are directly linked to airlines.

A variety of models can be adopted, and the details may be determined by the economic considerations involved. As an example, some Card Issuers 130 retain control of the funds from the time when card spend occurs until redemption of points with the Card Issuer 130 enjoying the benefit of the “float” until redemption.

Reward points are in any case allocated against a reward account of the Card Holder 120 for future redemption on available “rewards”, in accordance with the terms and conditions of the relevant reward programme.

Procedural Overview

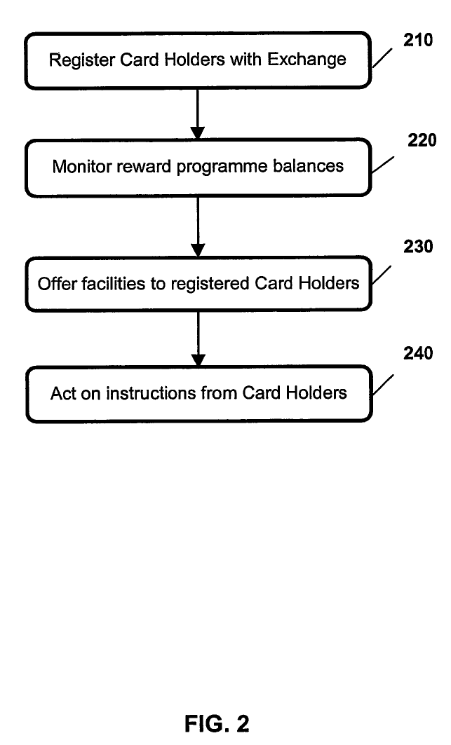

FIG. 2 schematically represents steps involved in the provision of exchange services, via Exchange 110. Card Holders 120 register with the Exchange 110 in step 210. Reward programme accounts are monitored on behalf of registered Card Holders 120 in step 220. Exchange services are offered to Card Holders 120 via the Exchange 110 in step 230. The offered services include a buy/sell facility, a transfer facility and a redemption facility as described herein in further detail. The Exchange 110 receives and transacts the instructions from Card Holders 120 in step 250.

Transactions with Exchange

Card Holders 120 accumulate points from Card Issuers 130 in accordance with the applicable reward programme. As described herein, points may be generally issued at a rate of 1 point for each dollar spent on particular goods or services. The accumulated points issued in accordance with the reward programme have a notional value of 1 cent per point. This notional value reflects the number of points approximately required to redeem rewards of a particular retail value. In other words, approximately 10,000 points might be required for a reward having an approximate value of $100. These values can vary, but a notional correspondence of value exists.

Purchases made by Card Holders 120 generate reward points that are allocated against an account of reward points in the name of the Card Holder 120. This account of reward points is stored at the Card Issuer 130, and is stored by or accessible by the Exchange 110.

Average redemption rates of points by Card Holders 120 conform to a relatively regular pattern. This pattern is estimated as follows: 10% in year 1, 30% in year 2, and 60% in year 3. These rates are affected by the number of points accumulated in years 1 and 2, as the reward programme members have not accrued enough points to redeem anything significant in the these years.

For the transactions described below, illustrative trading rates are intended to compensate for an expected increased redemption rate. That is, the effective redemption rate is reduced. Even in the case of heavy trading in reward points, a 100% redemption rate is unlikely as many Card Holders 120 never redeem points, and points are forfeited when Card Holders 120 have accounts cancelled or closed before all accumulated points are fully redeemed.

“breakage” occurs when points reach their “expiry date” and are unredeemed. Most Card holders 120 who use the Exchange 110 can be expected to trade their points at some time, and be active members of the reward programme offered by the Card Issuer 130. Although the increased utility provided by the “Exchange” causes a reduction in the breakage level, which is typically about 15% to 20% per year, the sharing of revenue streams of the Exchange 110 with the Card Issuers 120 compensates for this reduction.

Selling Points to Exchange

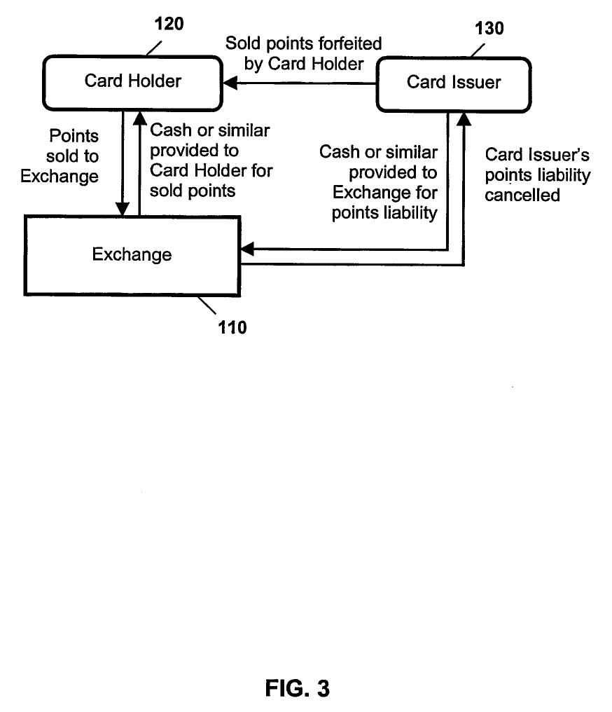

FIG. 3 schematically represents the sale of reward points from the Card Holder 120 to the Exchange 110. Card Holders 120 can sell their accumulated points to the Exchange 110 for a cash credit at a discount to their notional value. An indicative rate for the sale of points by Card Holders 120 to the Exchange 110 may be a rate between 15% and 50% of the notional value of the points. A rate of one third of the notional value may be selected; that is, 33%, or one-third of a cent per point. The Exchange 110 receives revenue from the Card Holder 120, which is shared with the Card Issuer 130. Effectively, the contingent liability of the Card Issuer 130 is reduced.

Reward points that are in the name of a Card Holder 120 can be sold to the Exchange 110. In this case, the Card Holder 120 instructs the Exchange 110 to buy a certain amount of points from the Card Holder 120. The Exchange 110 communicates securely with the provider 130 to debit the account of the relevant Card Holder 120, and pays the Exchange 110 an appropriate amount for “writing off” these debited points. The Exchange 110 then credits a banking account (such as a regular nominated banking account, or credit card) of the Card Holder 120 with a proportion of the amount received from the Card Issuer 130.

Buying Points from Exchange

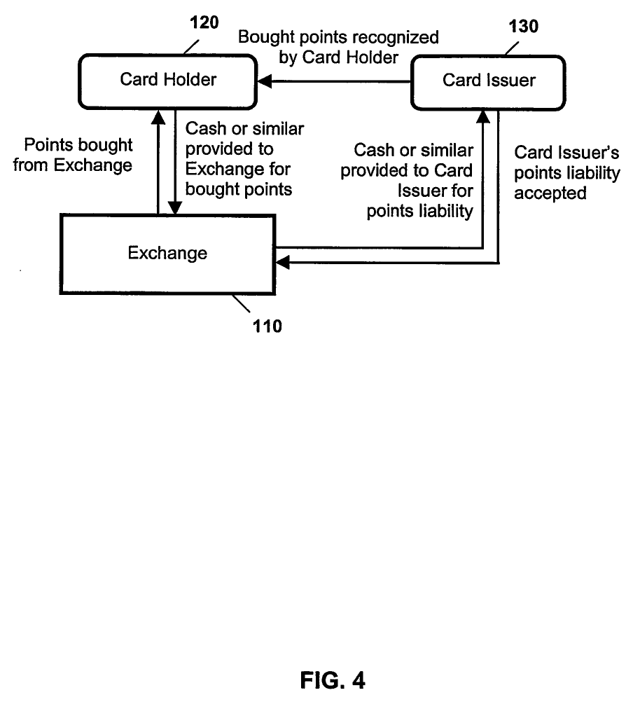

FIG. 4 schematically represents the purchase of reward points by the Card Holder 120 from the Exchange 110. Card Holders 120 can buy further points from the Exchange 110 at a premium to their notional value. An indicative rate for the purchase of points from the exchange by Card Holders 120 may be a rate between 125% and 350% of the notional value of the points. A premium of 300%, for example, may be selected. Different rates may apply to different volumes of points, so Card Holders 120 effectively receive a discount for bulk purchase. The contingent liability of the Card Issuer 130 increases, but the revenue received by the Exchange 110 is shared with the Card Issuer 130.

Reward points that are in the name of a Card Holder 120 can be supplemented by additional points purchased from the Exchange 110 at a premium. The Card Holder 120 interacts with the Exchange 110, instructing the Exchange 110 to purchase additional points from a Card Issuer 130, using a payment facility such as a credit card. The Exchange 110 communicates securely with the Card Issuer 130 to purchase reward points, to the credit of the Card Holder 120, from the reward programme provider 130. The Exchange 110 charges the Card Holder 120 and pays the Card Issuer 130 at rates involving a suitable margin.

Transferring Points Between Reward Programmes

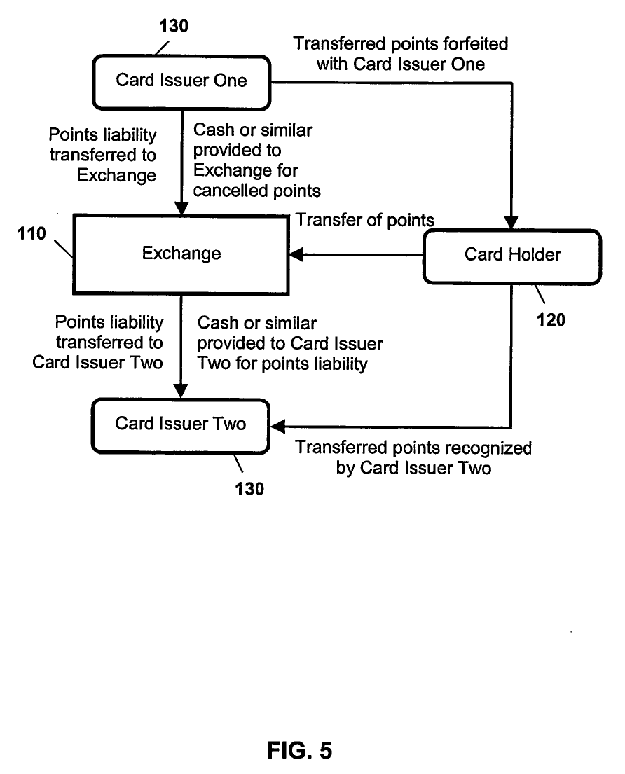

FIG. 5 schematically represents the transfer of reward points by the Card Holder 120, via the Exchange 110, between reward programmes provided by different Card Issuers 130. Card Holders 120 can transfer points between Reward Programmes, at a discount to the notional value of the transferred points. An indicative rate for the transfer of points at the exchange by Card Holders 120 may be a rate between 30% and 70% of the notional value of the points. A discount of 50%, for example, may be selected. A transfer of points is effectively a combination of purchasing and selling points, but with different Card Issuers 130 involved in either side of the transaction.

Reward points that are in the name of a Card Holder 120 can be transferred at the Exchange 110 between accounts of Card Issuers 130. In this case, the Card Holder 120 is instructs the Exchange 110 to buy transfer a certain amount of points from one Card Holder 120 to another Card Holder 120. Such a transaction is essentially a combination of selling reward points to the Exchange 110, and buying reward points from the Exchange 110. Clearly, in this case, the reward points sold and bought are of a different type, and involve different Card Issuers 130.

Redeeming Points for Reward Via the Exchange

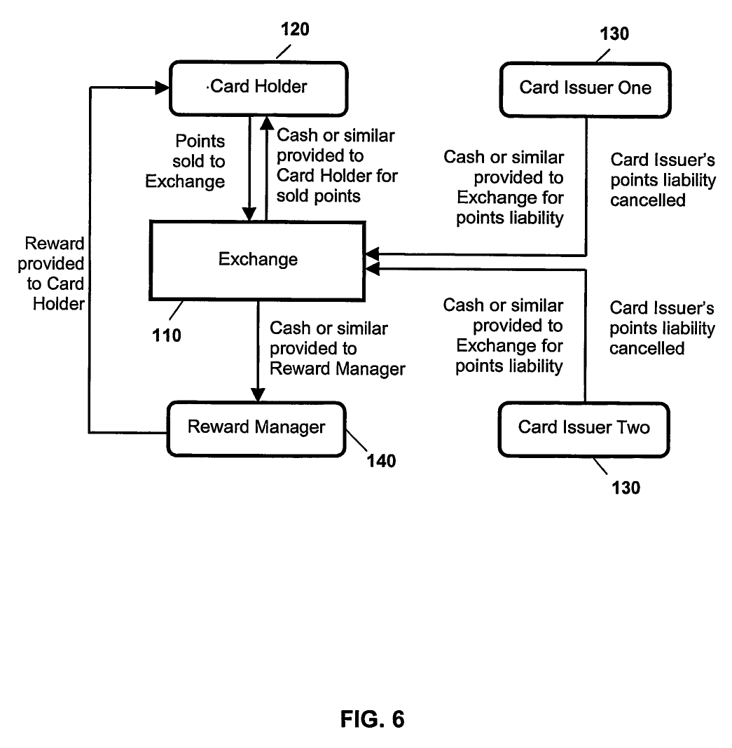

FIG. 6 schematically represents the redemption via the Exchange 110 of reward points by the Card Holder 120 for a reward. Card Holders 120 can redeem their reward points with the Exchange 110 for rewards. Rewards are provided by a Reward Manager 140, as specified by the Card Holder 120. The reward options available to Card Holders 120 are provided by the Reward Manager 140. The points cost for redeeming points via the Exchange 110, using the Rewards Manager 140 is based upon a retail cost of the reward, plus a 12.5% points premium for redemption. The notional value of the points, namely 1 cent per point, applies in determining the corresponding points required to redeem the points for the specified reward.

Typically, reward points from different Card Issuers 130, Card Issuer One 130 and Card Issuer Two 130 in FIG. 6, are consolidated via the Exchange 110 by the Card Holder 120. This can provide with Card Holder 120 with enough points to redeem a desired reward.

A wholesale-retail margin relating the wholesale cost of the reward to the Exchange 110, relative to the retail value of the reward, may apply. This provides further revenue to the Exchange 110 that can be shared between relates parties, namely the Card Issuer 130 and the Reward Manager 140. This wholesale-retail margin is not expected to be available for rewards that relate to airline travel. Accordingly, the revenue model differs if this margin is not available to the Exchange 110, consequently changing the revenue flows from the Exchange 110 to related parties.

Redemption of points for a reward with the Exchange 110 may also involve the purchase of additional points by the Card Holder 120 from the Exchange 110, as described above, to reach a points milestone at which the reward is available to the Card Holder 120.

Analysis of Operations

A notional value of 1 cent per point is described herein. Reward points, however, actually cost a Card Issuer 130 less than this notional value. Contributing factors to this reduction in cost might be contributions made by retailers through transaction fees, wholesale-retail margins and other factors that may be applicable. As an example, reward points have an underlying cost to Card Issuers 130 of 0.8 cents per point. A Card Issuer 130 may, for example, determine that the Card Issuer 130 supports the reward programme to a cost of 0.8 cents per point. Accordingly, the Card Holders 120 are provided, effectively with a level of service that is available for a cost of 0.8 cents per point. A Card Issuer 130 may select another cost of points, such as 0.78 cents per point, or 0.82 cents per point. Generally, internal points cost for Card Issuers 130 might vary from between about 0.75 cents per point to about 0.85 cents per point. The cost per point is indicative only, and can be varied to be any level that offers a level of service acceptable to Card Holders 120.

An effective cost of providing reward points to Card Holders 120, on a per point basis, is found by multiplying the cost of points by the redemption rate. This relationship is presented in Equation [1] below.
real cost [rc]=cost [c]×redemption rate [r] [1]

Consider an example in which the cost of points (to a Card Issuer 130) is 0.66 cents per point, and the redemption rate rises to 95%. Using Equation [1] above, the real cost of providing reward points is 0.63 cents per point, a 17% reduction compared with a cost of 0.8 cents per point indicated above.

Table 1 below presents a simplified analysis of the cash flows and “point flows” involved in financing a typical transaction made in accordance with the reward programme.

TABLE 1
Card Holder 120 makes $1000 purchase from retailer using card issued by
Card Issuer 130.
Card Issuer 130 allocates 1,000 reward points to Card Holder 120 in
accordance with reward programme.
Retailer pays 2% (that is, $20) transaction fee on purchase by Card Holder
120.
Card Holder 130 allocates a certain percentage of the transaction fee to
finance the reward programme.
Card Holder 120 redeems 10,000 accumulated points for an electrical
appliance from Reward Manager 140.
Card Issuer 130 incurs a cost of points the from Reward Manager 140 for
supplying the electrical appliance.

Revenue Model

Incoming revenue for the Exchange 110 is shared with the Card Issuers 130 via a series of rebates as described in further detail below. Revenue is generated for the Exchange 110, while effectively reducing the “point cost” to Card Issuers 130 by passing on a share of this revenue to Card Issuers 130. Reward Managers 140 are also compensated by the Exchange 110 for providing rewards to Card Holders 120.

Transactions are conducted with the Card Issuers 130 such that points are valued at a common cost of 0.8 cents per point, as an example, and as described herein. A series of rebates are then provided to Card Issuers 130 as agreed between Card Issuers 130 and the Exchange 110. If certain Card Issuers use a different “cost of points”, 0.78 cents per point as an example, then the rebates available to that Card Issuer 130 can be reduced, or the reward points charged to the Card Holders 120 of that Card Issuer 130 can be varied. A combination of both these measures can also be adopted.

Card Issuers 130 have the following revenue streams associated with their relationship with the Exchange 110.
A rebate is paid to the Card Issuer 130 as a proportion of the retail margin on any goods and services redeemed by a Card Holder 120 who deals with the Exchange 110.
A share of the income from the sale of any points to the Exchange 110 by a Card Holder 120 who redeems points for a discounted cash value of the points.
A share of the income from any points purchased by a Card Holder 120 who purchases points from the Exchange 110 to reach a points “milestone”.
A proportion of the income from Card Holders 120 for subscription to the Exchange 110. Such subscription fees are proposed, as an example, as $30 per annum for a first reward programme, with a further $10 for each further reward programme nominated.
A profit share of the Exchange 110 can be allocated between Card Issuers 130, and is calculated on the value of transactions conducted by their respective Card Holder 120. The profit share may be, as an example, 20% of the profit made by the Exchange 110.

Besides various fees that may be levied on Card Holders 120 (for example, annual fees, transaction fees), revenue can be earned by Card Issuers 130 from margins on trading in points. Each Card Holder 120 who deals with the Exchange 110 may be charged an annual processing fee, for example, $20.00. Additional fees may be charged for additional reward programmes registered with the service. Each Card Holder 120 registered with the Exchange 110 may be issued with a card and PIN to facilitate security of transactions. These margins, using the example figures indicated above, are as follows.
Purchase of points from Card Holders 120 (at 0.33 cents per point) and sale of points to providers (0.66 cents per point) provides a margin of 0.33 cents per point.
Transfer of points by Card Holders 120 between programmes (at 0.50 cents per point) and sale of transferred points to providers (at 0.66 cents per point).
Differential rates can apply to different Card Holders 120 in a reward programme. For example, “gold” or “premium” members may be offered a more favourable conversation rate than regular members.

There is also, of course, a margin between the wholesale and retail prices of goods and services that are used as rewards and for which points are redeemed. Rewards provided to Card Holders 120 are likely to be subject to the usual wholesale-retail margin that exists for wholesale rather than retail purchases. The margin between wholesale and retail costs may, as an example, be 40% of retail cost. If such a margin is available to the Exchange 110 or Reward Manager 140 via usual wholesale-retail arrangements, the retail price of reward points can be adjusted accordingly before adding a 12.5% points premium described in relation to the examples described herein. The wholesale-retail margin may be greater than 40% of the retail cost, in which case a consequent adjustment in favour of the Exchange 110 results. The price of any item in terms of required points to Card Holders 120 is expected to be based upon the retail cost of the reward, plus a 12.5% points premium. Conversion of the retail cost of the reward to a corresponding points cost is based upon the notional value of the points, namely 1 cent per point, as described herein.

The indicative figures described above are negotiated as required between the various entities, and are not definitive or comprehensive.

Transaction Conditions

The implementation described for the Exchange 110 establishes various transaction conditions that apply to trading in reward points by Card Holders 120, as described below. These transaction conditions can be varied in form or substance as required.
(i) Prices of rewards redeemed by Card Holders 120 have a points cost equivalent to the corresponding retail cost plus a 12.5% points premium. The notional points value of 1 cent per point applies in determining the points cost equivalent.
(ii) The minimum number of points that can be redeemed for cash is 10,000 points ($100) with block increments of 5,000 after the first 10,000 points purchase (namely, $150, $200, etc).
(iii) The minimum number of points that can be purchased to reach a reward milestone is 1,000. The first 5,000 points, or any part thereof, costs three cents per point. Remaining points that are purchased at a rate of two cents per point.
(iv) An annual limit on the monetary amount that can be realised by Card Holders 120 can be established. As an example, a limit of 40,000 points, which would realise $240, may be applied. Such an amount can be directed to subscription to the services of the Exchange 110, or the reward programme offered by the Card Issuer 130.
   Example Transactions

Described below with reference to accompanying tables are various examples of transactions that Card Holders 120 can initiate with the Exchange 110. The figures selected in each example are indicative only, and are selected to illustrate the transactions that can be initiated via the Exchange 110. The rates, figures and percentages used in these examples are a matter of commercial negotiation are thus subject to variation as is apparent to one skilled in the art. Such rates, figures and percentages are approximate rather than exact, and can be varied required to achieve the same or a similar commercial objective.

### EXAMPLE

### Selling Points to Exchange

Table 2 below presents two examples of the sale of reward points to the Exchange 110 by Card Holders 120.

TABLE 2

| | | |
|---|---|---|
| Card Holder initial points account | 10,000 | 50,000 |
| Points sold to Exchange by Card | 10,000 | 50,000 |
| Holder | | |
| Value paid by Exchange for points | 0.33 cents per | 0.33 cents per |
| | point | point |
| Exchange pays Card Holder for points | $33.00 | $165.00 |
| Exchange onsells points | 0.55 cents per | 0.55 cents per |
| | point | point |
| Exchange receives payment from Card | $55.00 | $275.00 |
| Issuer for cancelled points | | |
| Exchange retains a margin of 0.22 cents | $22.00 | $110.00 |
| per point | | |
| Initial cost of points to Card Issuer at | $80.00 | $400.00 |
| 0.8 cents per point | | |
| Reduction of point cost (0.8 cents less | $25.00 | $125.00 |
| 0.55 cents per point | | |
| New point cost to provider | $55.00 | $275.00 |
| Actual redemption rate | 100% | 100% |
| Effective redemption rate | 55% | 55% |
| Card Issuers reduces Contingent | 10,000 | 50,000 |
| liability associated with points | | |

Table 3 below presents two further examples of the sale of reward points to the Exchange 110 by Card Holders 120. The minimum number of points that are purchased by the Exchange 110 can be set at a lower threshold, such as 10,000 points. Table 3 represents the case in which the Card Holder 120 has 9,000 points or 11,000 points, and sells 10,000 points to the Exchange 110 in each case.

TABLE 3

| | | |
|---|---|---|
| Card Holder accumulated points with Card | 9,000 | 11,000 |
| Issuer | | |
| Points transferred to Exchange | 9,000 | 11,000 |
| Card Holder must have minimum of | 1,000 | — |
| 10,000 points - additional points required | | |
| Card Holder buys required points from | $30.00 | — |
| Exchange (at 3 cents per point) | | |
| Card Holder total points sale | 10,000 | 10,000 |
| Exchange revenue from Card Issuers | $72.00 | $80.00 |
| (sale of points at 0.8 cents per point) | | |
| Exchange total revenue on transaction | $102.00 | $80.00 |
| from Card Issuer and Card Holder | | |
| Exchange pays Card Holder for received | $60.00 | $60.00 |
| points (at 0.6 cents per point) | | |
| Exchange net after Card Holder paid | $42.00 | $20.00 |
| Exchange pays Card Issuer 50% of balance | $21.00 | $10.00 |
| Exchange net profit | $21.00 | $10.00 |
| Card Issuer cost of points | $51.00 | $70.00 |
| Card Issuer's cost per points | 0.51 cents | 0.70 cent |
| Card Holder points remaining | — | 1000 |

### EXAMPLE

### Buying Points from Exchange

Table 4 below presents example in which a Card Holder 120 has 60,000 reward points accumulated, and needs an extra 7,500 points to reach a 67,500 points milestone at which a desired reward can be achieved. The example of Table 4 below illustrates a case in which the points are subsequently redeemed for a reward.

TABLE 4

| | |
|---|---|
| Card Holder accumulated points on account | 60,000 |
| Card Holder buys additional points from Exchange | $200.00 |
| first 5,000 points at 3 cents per point | $150.00 |
| remaining 2,500 points at 2 cents per point | $50.00 |
| Card Holder points on account after purchase | 67,500 |
| Retail cost of Card Holder's selected reward | $600.00 |
| to Card Issuer | |
| Wholesale cost of this same selected reward | $360.00 |
| Wholesale-retail margin | $240.00 |
| Exchange revenue from Card Issuer | $480.00 |
| (sale of 60,000 points at 0.8 cents per point) | |
| Exchange revenue from Card Holder | $200.00 |
| (sale of 7,500 points as above) | |
| Exchange total revenue on transaction from Card | $680.00 |
| Issuer and Card Holder | |
| Exchange total revenue less wholesale cost of | $320.00 |
| reward | |
| Exchange pays 20% of total revenue to Card Issuer | $64.00 |
| Exchange also pays Reward Manager 50% of | $128.00 |
| balance after Card Issuer's 20% | |
| Exchange net profit | $128.00 |

In essence, the Card Issuer 130 reduces their contingent liability in points held on account on behalf of Card Holders 120. Card Holders 120 can conveniently achieve points milestones and thus desired rewards. The Exchange 110 generates a net profit on transactions, and indirectly shares a portion of this profit with the Card Issuer 130.

### EXAMPLE

### Transferring Points from One Card Issuer to Another Via Exchange

Reward points held by a Card Holder 120 are transferred from a reward programme provided by first Card Issuer 130 to a reward programme with a second Card Issuer 130. A “transfer charge” applies to the Card Holder 120 as a proportion of the amount of points being transferred. As an example, a rate of 33% is used in the illustrative figures provided below. The first Card Issuer 120 pays the Exchange 110 for the “cancelled” points at their cost value, which are now not the responsibility of the first Card Issuer 120. Additional points transferred to the second Card Issuer 120 are taken as additional to liability, and the Exchange 110 pays the second Card Issuer 120 at the cost value of the points.

When more than one Card Issuer 130, or reward programme, is involved in the consolidation and accumulation of reward points the cash rebate is 20% of the respective points cost liability of the Card Issuer 130. This arrangement make the rebate “equal” for all participating Card Issuers 130. Only two Card Issuers 130 used in the example provided in the example of Table X below. Reward points with more than two Card Issuers 130 can be consolidated by Card Holders 120.

Table 5 below presents an example in which 15,000 points with a first Card Issuer 130 are transferred to a second Card Issuer 130.

TABLE 5

| | |
|---|---|
| Rewards points with Card Issuer One | 15,000 |
| Rewards points with Card Issuer Two | 30,000 |
| Transfer charge of 33% on transferred points‘ | 5,000 |
| Rewards points with Card Issuer One after transfer | 0 |
| Rewards points with Card Issuer Two after transfer | 40,000 |
| Card Issuer One pays Exchange value of transferred | $120.00 |
| points at 0.8 cents per point for 15,000 points | |
| Card Issuer Two for additional liability of | $80.00 |
| transferred points (15,000 less 5,000 charge at 0.8 | |
| cents per point) | |
| Total points liability for Card Issuer Two is now | $320.00 |
| 40,000 points at 0.8 cents per point | |
| Card Issuer Two points are redeemed by Card | |
| Holder via Exchange on $400 reward | |
| Wholesale-retail margin at 30% on $400 reward | $120.00 |
| Card Issuer Two pays Exchange value of redeemed | $320.00 |
| points at 0.8 cents per point | |
| Exchange pays Rewards Manager wholesale cost | $320.00 |
| plus 50% of wholesale-retail margin | |
| Exchange revenue from Card Issuers One and Two, | $160.00 |
| and wholesale-retail margin | |
| Exchange pays Card Issuer Two 25% of total | $80.00 |
| liability | |
| Exchange pays Card Issuer One 25% of original | $30.00 |
| liability | |
| Exchange retains after outgoings | $50.00 |

### EXAMPLE

### Redeeming Points for a Reward Via the Exchange

Table 6 below presents an example in which a Card Holder 120 has 50,000 reward points accumulated, and wishes to redeem points to obtain a $300.00 reward. This requires 30,000 points, plus a 12.5% points premium. Accordingly, the total points required in 33,750 points.

TABLE 6

| | |
|---|---|
| Card Holder accumulated points on account | 50,000 |
| Card Holder transfers 35,000 points to Exchange | 35,000 |
| Card Holder points not used in purchase | 1,250 |
| Retail cost of Card Holder's selected reward | $300.00 |
| to Card Issuer | |
| Wholesale cost of this same selected reward | $180.00 |
| Wholesale-retail margin | $120.00 |
| Exchange revenue from Card Issuer | $280.00 |
| (sale of 35,000 points at 0.8 cents per point) | |
| Exchange revenue from Card Holder | $0.00 |
| (none, as Card Holder supplies all points required) | |
| Exchange total revenue on transaction from Card | $280.00 |
| Issuer and Card Holder | |
| Exchange total revenue less wholesale cost of | $90.00 |
| reward and less points not used | |
| Exchange pays 20% of total revenue to Card Issuer | $18.00 |
| Exchange also pays Reward Provider 50% of | $36.00 |
| balance after Card Issuer's 20% | |
| Exchange net profit | $36.00 |

### EXAMPLE

### Consolidating, Purchasing and Redeeming Points Using the Exchange

Table 7 below presents an example in which a Card Holder 120 has 18,000 reward points accumulated with a first Card Issuer 130, and 30,000 reward points accumulated with a second Card Issuer 130. The Card Holder 120 wishes to redeem points to obtain a $500.00 reward. This requires 50,000 points, plus a 12.5% points premium. Accordingly, the total points required in 56,250 points.

TABLE 7

| | |
|---|---|
| Card Holder accumulated points with first Card | 18,000 |
| Issuer | |
| Card Holder accumulated points with second Card | 30,000 |
| Issuer transfers | |
| Card Holder has points available via Exchange | 48,000 |
| Card Holder requires points for selected reward | 56,250 |
| Card Holder requires points balance | 8,250 |
| Card Holder buys additional points from Exchange | $215.00 |
| first 5,000 points at 3 cents per point | $150.00 |
| remaining 2,500 points at 2 cents per point | $65.00 |
| Retail cost of reward | $500.00 |
| Wholesale cost of this same selected reward | $300.00 |
| Wholesale-retail margin | $200.00 |
| Exchange revenue from Card Issuers | $384.00 |
| (sale of 48,000 points at 0.8 cents per point) | |
| Exchange revenue from Card Holder | $215.00 |
| (none, as Card Holder supplies all points required) | |
| Exchange total revenue on transaction from Card | $599.00 |
| Issuer and Card Holder | |
| Exchange total revenue less wholesale cost of | $299.00 |
| reward | |
| Exchange pays 20% Rebate to Card Issuer | $59.80 |
| Exchange also pays Reward Provider 50% of | $119.60 |
| balance after Card Issuer's 20% Rebate | |
| Exchange net profit | $119.60 |

Points Purchased Airfares

The average spend for a Card Holder 120 to receive a $150 flight is about $15,000. As well as being a member of the reward programme offered by the Card Issuer 130, the Card Holder 120 is also required to be a member of the reward programme (typically a “frequent flyer programme”) offered by the relevant airline.

Every Card Holder 120 who joins the applicable frequent flyer programme costs the Card Issuer 130 1.3 cents per point to support the points transferred by the Card Holder 120 to the frequent flyer programme. A number of Card Issuers 130 offer an alternate service to their Card Holders 120. Card Holders 120 can purchase an airfare at the current retail price using their points, with the facility to top up any shortfall with cash. This enables the Card Holders 120 to fly at their convenience, providing there is a flight available, with a fully paid and booked ticket.

The points pricing of these purchased tickets is, however, significantly higher by a factor of about 50%. By contrast, the flight cost might be $220 rather than $150 for a confirmed booking.

If such an option is provided to Card Holders 120 by the Exchange, the Card Issuer 130 would not receive a rebate from the Exchange 110 for the transaction but would be compensated by a 20% profit share as described herein. The Card Issuer 130 is not required to support the points of the airline's frequent flyer programme at 1.3 cents per point, and also saves about 50% on points cost.

Combined Points/Cash Redemption

As an alternative to rewards provided by a Reward Manager 140, rewards may also be available to Card Holders 120 at a retail level. As an example, a combination of reward points and an accompanying cash contribution might be used to “purchase” a reward at a retail store. The retail store can be compensated by the Exchange 110 as agree by the Exchange 110 and the retail store.

Accordingly, a point/cash redemption calculator can be provided to Card Holders 120 for calculation of the component points and cash required to obtain a particular reward. Consider an example of a $100 gift voucher from a department store. A premium of 12.5% is charged in the number of points; that is, to a point 12.5% bonus points are provided for every hundred dollars spent. As a discount is received from the supplier, in this case the department store, the total benefit is more likely to be in the vicinity of 25% to 30% on a one hundred dollar reward purchase. Second, in a cash and points mixed purchase of an item from a rewards catalogue, the points premium is still 12.5%.

Currently, such mixed transactions are approximately 50% cash and 50% points. A sliding scale can be introduced in the cash/points calculator. Any cash component under 50% attracts a higher points premium rate, operating from a 50% cash component down to a 30% cash component. In this case, 30% represents the minimum cash component, although this can vary depending on the wholesale cost of the reward item. In this context, a further 10% points premium per 5% less cash component down to a minimum of 30% cash component may apply.

Table 8 below outlines an example relating to a reward of $1,000 retail price.

TABLE 8

| | | |
|---|---|---|
| 1. | Cash component 50% | $500 |
| | Points component 50% (at 1 cent per point) | 562,500 |
| 2. | Cash component 40% | $400 |
| | Points component 60% plus 20% premium | 810,000 |
| 3. | Cash component 30% | $300 |
| | Points component 70% plus 20% premium | 945,000 |

System Architecture

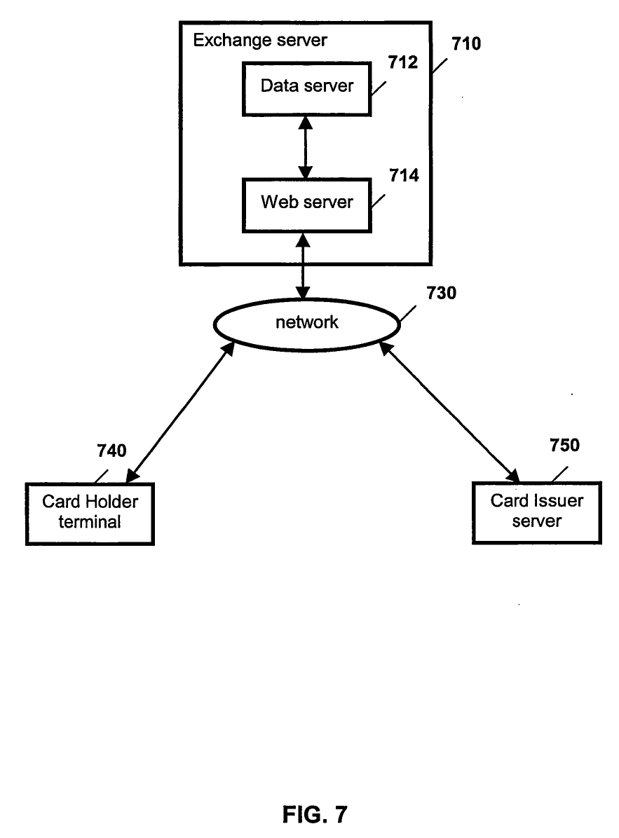

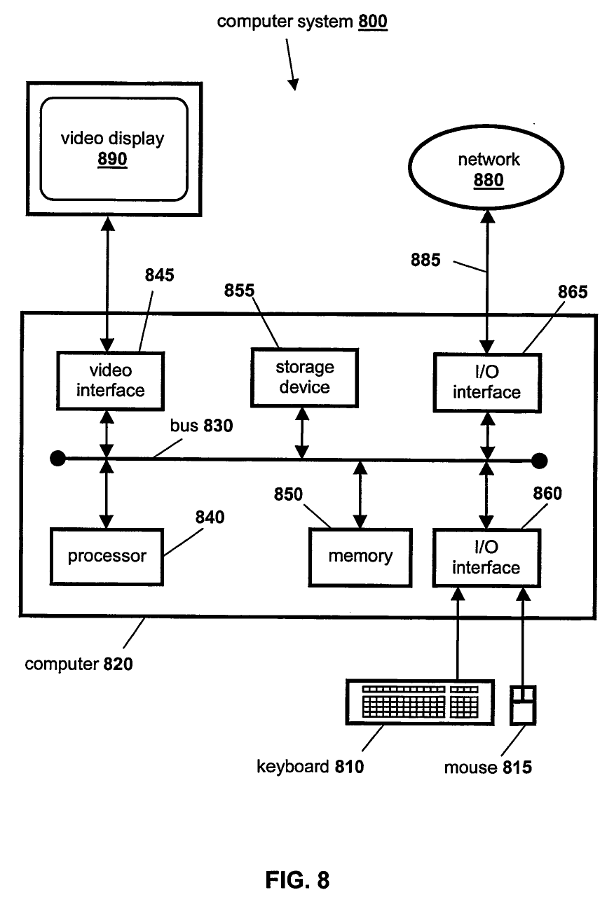

FIG. 7 schematically represents an architecture used for providing services associated with the Exchange 110. An Exchange server 710 comprises both a data server 712 and a web server 714. The web server 714 is connected to the Internet 430. Card Holder terminals 740, and Card Issuer servers 750 are able to communicate via the network 730 with the Exchange server 710, to access information stored on the data server 710. Computer systems of the type described below with reference to FIG. 8 are used to provide the Exchange server 710, Card Holder terminals 740 and Card Issuer servers 750.

The data server 712 stores the information relating to accounts for Card Holders 120, and administers transactions made by Card Holders 120 and Card Issuers 130 with the Exchange 110. The web server 714 uses communications software products and other relevant software infrastructure to enable required communications functionality. The data server 712 uses database software products, and other relevant software infrastructure to provide the above-described services to Card Holders 120 and Card Issuers 130.

The Exchange server 710 stores customer data for the Card Holders 120, and is able to be accessed by Card Holders 120 using Card Holder terminals 740. Similarly, Card Issuers 130 can also access, via the network 730, the Exchange server 710.

The computer systems of the Exchange 110, namely Exchange server 710 is electronically linked with those of the Card Issuers 130, namely Card Issuer servers 740 so that their respective electronic records are maintained in agreement with each other. Card Holders 120 can access the Exchange 110 to instruct transactions and confirm their current account status.

The Exchange 110 facilities the transfer of points between Card Holders 120 in reward programmes. In this respect, transactions performed using the Exchange 110 are reported to all relevant reward programme providers so that Card Issuers 130 can track how many points are on issue to which Card Holders 120.

Computer Hardware

FIG. 8 is a schematic representation of a generic computer system 800 that can be used to implement reward points transactions described herein. The computer system 800, as described below, is suitable for use as an Exchange server 710, Card Holder terminal 740, or the Card Issuer server 750. When used for these different purposes, the performance capabilities of the computer system 800 are adapted as required. The generic architecture of each computer system is essentially unchanged. Modifications are, however, possible. As an example, the Card Issuer server 750 and Exchange server 710, require greater storage and data processing capabilities compared to the Card Holder terminal 740. Consequently, the Card Issuer server 750 and Exchange server 710 may use a multiprocessor architecture rather than the uniprocessor architecture represented in the computer system 800 of FIG. 8. Further storage devices and memory may be provided in the Card Issuer server 750 and Exchange server 710, compared to the storage device 855 and memory 850 of the computer system 800.

Computer software executes under a suitable operating system installed on the computer system 800 to assist in performing the described techniques. This computer software is programmed using any suitable computer programming language, and may be thought of as comprising various software code means for achieving particular steps.

The components of the computer system 800 include a computer 820, a keyboard 810 and mouse 815, and a video display 890. The computer 820 includes a processor 840, a memory 850, input/output (I/O) interfaces 860, 865, a video interface 845, and a storage device 855.

The processor 840 is a central processing unit (CPU) that executes the operating system and the computer software executing under the operating system. The memory 850 includes random access memory (RAM) and read-only memory (ROM), and is used under direction of the processor 840.

The video interface 845 is connected to video display 890 and provides video signals for display on the video display 890. User input to operate the computer 820 is provided from the keyboard 810 and mouse 815. The storage device 855 can include a disk drive or any other suitable storage medium.

Each of the components of the computer 820 is connected to an internal bus 830 that includes data, address, and control buses, to allow components of the computer 820 to communicate with each other via the bus 830.

The computer system 800 can be connected to one or more other similar computers via a input/output (I/O) interface 865 using a communication channel 885 to a network, represented as the Internet 880.

The computer software may be recorded on a portable storage medium, in which case, the computer software program is accessed by the computer system 800 from the storage device 855. Alternatively, the computer software can be accessed directly from the Internet 880 by the computer 820. In either case, a user can interact with the computer system 800 using the keyboard 810 and mouse 815 to operate the programmed computer software executing on the computer 820.

Other configurations or types of computer systems can be equally well used to implement the described techniques. The computer system 800 described above is described only as an example of a particular type of system suitable for implementing the described techniques.

Web-Based Implementation

The Exchange 110 can be provided by a World Wide Web (WWW) site, operated by the web server 714 of the Exchange server 710. The web site has an interface that provides for registration of personal details of Card Holders 120. Card Holders 120 also register the details of the reward programmes, operated by Card Issuers 130, in which the Card Holders 120 participate. Card Holders 120 can register the details of more than one reward programme.

The data server 712 of the Exchange server stores and updates data provided by Card Holders 120, and maintains records relating to transactions of rewards points involving Card Holders 120 and Card Issuers 130.

Electronic Funds Transfer Network Implementation

Services provided by the Exchange 110 can be accessed in one implementation using a financial services network 730, such as an electronic funds transfer (EFT) network. In this case the Card Holder terminals 740 are not personal computers of the type described in relation to computer system 800. Instead, the Card Holder terminals can be Electronic Funds Transfer at Point of Sale (EFTPOS) terminals. EFTPOS terminals typically have a magnetic card reader for reading magnetic cards provided by a user, a display for displaying messages to the user, and a keypad for entering data prompted by the display.

EFTPOS terminals are typically provided at retail counters to facilitate electronic payments via debit and credit cards. Users swipe their debit or credit card through the magnetic swipe card reader to allow the reader to access account and other details encoded in the magnetic strip of the card.

An example of an EFTPOS terminal is the Keypay EFT terminal (K17i) model supplied by Keycorp Limited of Sydney, Australia. As well as accepting magnetic strip cards, the abovementioned K17i model also accepts smart cards to facilitate electronic transactions via the EFT network.

In an EFT-based service channel, a Card Holder 120 can use a card, such as a magnetic stripe card or smart card, issued by the Exchange 110. The card issued by the Exchange 110 records the account details of the Card Holder 120 with the Exchange 110, so that the Card Holder 120 can be identified by the Exchange 110 details when the Card Holder 120 uses the card with the EFTPOS terminal.

The Card Holder 120 can be prompted to enter a PIN, if applicable, to authenticate them as the owner of the card, as is provided for with debit card transactions using the EFT network. Instead of paying for a retail transaction using a debit or credit card, however, the Card Holder 120 can pay for the relevant goods or services using points held on account with the Exchange 110. The point of sale staff checks the applicable number of reward points for approval by the Card Holder 120.

The reward points used by the Card Holder 120 to “purchase” the reward are cancelled at the Exchange 110. The retailer who has provided the reward to the Card Holder 120 is appropriately compensated by the Exchange 110, which is compensated by the Card Issuer 130 as generally described herein.

Points Accounting

Reward points are issued to Card Holders 120 by Card Issuers 130 in accordance with the terms and conditions of the relevant reward programme. Details of reward points accumulated by Card Holders 120 are stored by the Card Issuers 130 in their records, typically in an electronic manner in a Card Issuer server 750. An account statement of accumulated reward points is, typically, regularly provided to Card Holders 120 by Card Issuers 130. Typically, a catalogue of reward options available to Card Holders 120 is also regularly provided so that Card Holders 120 can redeem their points as the Card Holders 120 wish.

Some Card Issuers 130 may provide a facility to allow Card Holders 120 to electronically access an account statement of their accumulated reward points held with the Card Issuer 130. In many cases, rewards can be redeemed via a telephone call centre facility provided to Card Holders 120. Operators staffing such telephone call centre facilities typically have access to the account details, including the accumulated reward points, held by the Card Holders 120.

When Card Holders 120 register with the Exchange 110, the Exchange 110 can arrange with the one or more Card Issuers 130 with which the Card Holder 120 is involved to maintain details of reward points account held by the Card Holder 120. A periodic secure electronic data transfer can be arranged to ensure that the account of reward points stored with the Exchange 110 matches the account of reward points stored with the Card Issuer 130. The data transfer need not be made via electronic transmission but, may, for security reasons, be achieved through physical transfer of a storage medium such as disk media. Similarly, “live” electronic access may be adopted rather than period electronic data transfer.

When the Exchange 110 intermediates transactions that have the effect of “creating” or “destroying” reward points, the reward points account recorded with the Card Issuer 130 needs to be updated accordingly. Consequently, the above-described data transfer operates in both directions so that the records of the Exchange 110 and the Card Issuer 130 both correctly reflect the reward points held by or owing to the Card Holder 120.

When points are issued to a Card Holder 120 by the Exchange 110, the number of reward points in the points account held by the Card Holder increases. Records maintained by the Exchange 110 and the Card Issuer 130 are undated accordingly. The Card Issuer 130 holds a liability associated with the reward points issued to the Card Holder 120, as the points have value by virtue of their ability to be redeemed with the Card Issuer 130 in accordance with the reward programme, or via the Exchange 110 as described herein.

When the Exchange 110 issues reward points to a Card Holder 120, the Card Issuer 130 recognizes these additional reward points under the reward programme. As the Card Issuer 130 assumes additional contingent liability associated with the reward points, the Card Issuer 130 is compensated accordingly as described herein. The Card Holder 120 pays for the additional reward points as also described herein.

Converse observations apply in relation to reward points that are cancelled by the Exchange 110. Records maintained by the Exchange 110 and the Card Issuer 130 are undated accordingly. The Card Issuer 130 reduces a liability associated with the reward points issued to the Card Holder 120.

Nature of Points Transfer

Transactions described herein involve issuing and cancelling reward points by the Exchange 110 to and from Card Holders 120. This issuing and cancelling of points is described herein with reference to the “selling” and “buying” of reward points to assist an understanding of the associated transactions. Similarly, transactions of the Exchange 110 with the Card Issuer 130 involve the creation or destruction of a liability (to honour reward points) owned by the Card Issuer 130 in accordance with the reward programme.

More particularly, the issue of reward points by the Exchange 110 to the Card Holder 120 involves creating a corresponding liability owned by the Card Issuer 130. Conversely, the cancelling of reward points by the Exchange 110 involves destroying a corresponding liability owned by the Card Issuer 130. The creation and destruction of such reward point liabilities is described herein with reference to the “selling and “buying” of reward points to assist an understanding of the associated transactions. The creation and destruction of such reward point liabilities is also described herein with reference to the “accepting” and “cancelling” of reward points liabilities to assist an understanding of the associated transactions. In the context of the Card Issuer 130, the associated change in reward points is described such that the reward points issued to the Card Holder 120 by the Exchange 110 are “recognized” by the Card Issuer 130, and the reward points cancelled by the Exchange 110 are “forfeited” by Card Holders 120.

The issuing and cancelling of reward points is initiated by Card Holders 120 following an offer by the Exchange 120 to enter such transactions as described herein. The Exchange 110, which intermediates in transactions involving the Card Holders 120 and Card Issuers 130, accepts requests from Card Holders 120 to proceed with such transactions. Similar considerations apply to the transfer or redemption of reward points. An arrangement exists between the Exchange 110 and the one or more Card Issuers 130 that transactions requested by Card Holders 120 of the Exchange 110 are acted upon by the Card Issuers 130 as agreed with the Exchange 110.

Nature of Cash Transfers

Exchange 110 intermediates transactions as described herein. Points are issued or cancelled, as described above. Reward point liabilities are created or destroyed as points are issued or cancelled. Cash or like consideration is also transferred as a result of transactions. Cash or like consideration is money that is transferred between entities involved in the transaction.

Cash or like consideration includes any cash-like consideration paid to another entity. Cash or like consideration encompasses actual cash, but can also be transferred as credit or debit items appearing on credit cards or debit cards. Deposits or withdrawals from banking accounts or similar facilities can also provide a means of transferring cash or like consideration between entities.

Typically, a credit item or debit item on a credit or debit card can be used to transfer cash or like consideration to or from Card Holders 120. Direct deposit or withdrawal facilities may be used to transfer cash or like consideration to or from Card Issuers 130. The transfer of cash or like consideration may not be simultaneous with a transaction, but may be made at, for example, a nominated accounting period, such as the end of a calendar month.

Further, transfer cash or like consideration to or from Card Issuers 130 can involve different monetary amounts, possibly transferred at different times. As an example, cash or like consideration may be paid for the cost of a point liability at 0.8 cents per point as described herein, and a later series of one or more rebates subsequently paid. Other variations are of course possible.

### CONCLUSION

Various alterations, modifications and additions can be made to the techniques and arrangements described herein, as would be apparent to one skilled in the relevant art.

While a computer terminal-based implementation is described above, access to Exchange 110 services could be provided via a telephone voice interface, or through an existing electronic exchange network, such as automatic teller machines. Public kiosk-based implementations are also possible.

Further, the techniques described herein can be implemented with the use of smart cards. A credit card, which is provided as a smart card, may store a current record of reward points accrued by the holder. Historical information, such as that relating to previous transactions or in-store redemption of reward points, can also be stored on the smart card. Transactions may be performed, for example, using an automated teller machine (ATM).

Other features are also possible. For example, while the primary function of the Exchange 110 is to exchange reward points, other “value-add” services can be provided to Card Holders 120. One example relates to trading in options and futures for underlying reward points.

1. A method of intermediating in a transaction involving a reward programme participant and a reward programme provider, the method comprising the steps of:
accepting a request from the reward programme participant to sell a specified number of reward points; and
receiving cash or like consideration from the reward programme provider for a reward points liability corresponding with the specified number of reward points issued by the reward programme provider to the reward programme participant; and
cancelling the specified number of reward points held by the reward programme participant for a cash or like consideration provided to the reward programme participant.

2. The method as claimed in claim 1, wherein the cash or like consideration received from the reward programme provider has a value corresponding with the cost of the reward points liability to the reward programme provider.

3. The method as claimed in claim 1, wherein the cash or like consideration provided to the reward programme participant has a value which is a discount to the notional value of the specified number of reward points.

4. The method as claimed in claim 1, wherein the cash or like consideration received from the reward programme provider has a value of about 75% to about 85% of the notional value of the specified number of reward points.

5. The method as claimed in claim 1, wherein the cash or like consideration provided to the reward programme participant has a value of about 30% to about 40% of the notional value of the specified number of reward points.

6. A method of intermediating in a transaction involving a reward programme participant and a reward programme provider, the method comprising the steps of:
accepting from the reward programme participant a request to purchase a specified number of reward points;
providing the reward programme provider with cash or like consideration for accepting a reward points liability corresponding with the specified of reward points requested by the reward programme participant; and
awarding the specified number of points to the reward programme participant for a cash or like consideration from the reward programme participant.

7. The method as claimed in claim 6, wherein the cash or like consideration received from the reward programme participant has a value which is a premium to the notional value of the specified number of reward points.

8. The method as claimed in claim 6, wherein the cash or like consideration provided to the reward programme provider has a value corresponding with the cost of the reward points liability to the reward programme provider.

9. The method as claimed in claim 6, wherein the cash or like consideration received from the reward programme participant has a value of about 200% to about 300% of the notional value of the specified number of reward points.

10. The method as claimed in claim 6, wherein the cash or like consideration provided to the reward programme provider has a value of about 75% to about 85% of the notional value of the specified number of reward points.

11. A method of intermediating in a transaction involving a reward programme participant and a reward programme provider, the method comprising the steps of:
accepting from the reward programme participant a request for a specified reward in consideration of a respectively specified number of reward points;
receiving cash or like consideration from the reward programme provider for a reward points liability corresponding with the specified number of reward points relating to the reward specified by the reward programme participant;
cancelling the specified number of reward points held by the reward programme participant; and
providing the specified reward to the reward programme participant in consideration of the respectively specified reward points.

12. The method as claimed in claim 11, wherein the specified number of corresponds with a retail value of the specified reward based at the notional value of the reward points, plus an additional predetermined percentage of reward points.

13. The method as claimed in claim 11, wherein the cash or like consideration received from the reward programme provider has a value corresponding with the cost of the reward points liability to the reward programme provider.

14. The method as claimed in claim 11, wherein the specified number of reward points received from the reward programme participant corresponds with a retail value of the specified reward at the notional value of the reward points, plus an additional percentage of reward points in the range of about 5% to about 20%.

15. The method as claimed in claim 11, wherein the cash or like consideration received from the reward programme provider has a value of about 75% to about 85% of the notional value of the specified number of reward points.

16. A method of intermediating in a transaction involving a reward programme participant and at least one reward programme provider, the method comprising
the steps of:
accepting from the reward programme participant a request to sell a first specified number of reward points held with a first reward programme provider; and
receiving cash or like consideration from the first reward programme provider for a reward points liability corresponding with the first specified number of reward points issued by the first reward programme provider to the reward programme participant; and
cancelling the first specified number of reward points held by the reward programme participant with the first reward programme provider for a cash or like consideration provided to the reward programme participant;
providing a second reward programme provider with cash or like consideration for a reward points liability corresponding with a second specified number of reward points; and
issuing the second specified number of reward points held with the second reward programme participant to the reward programme participant.

17. A system for intermediating in transactions involving reward programme participants and at least one reward programme provider, the system comprising:
at least one server for maintaining records of the reward programme provider;
terminals for initiating transactions involving reward points held by the reward programme participants;
a server for intermediating between reward programme participants and reward programme providers in the transactions initiated by the reward programme participants;
an electronic network linking the intermediating server with the participant terminals and provider server.

18. The system as claimed in claim 18, wherein the electronic network is a computer communications network.

19. The system as claimed in claim 18, wherein the electronic network is a financial services network.

20. A computer system for intermediating in transactions involving at least one reward programme participant and at least one reward programme provider, the computer system comprising:
a processor for processing transactions involving the reward programme participants and the reward programme provider;
a memory for storing structured data records that record: (i) reward points that are issued to a reward programme participant in exchange for cash or like consideration received from the reward programme participant, (ii) reward points held by a reward programme participant that are cancelled in exchange for cash or like consideration provided to the reward programme participant; and (iii) transfers of cash or like consideration that relate to reward point liabilities that are correspondingly created or destroyed as a result of (i) the issuing or (ii) the cancelling of the reward points;
a communications module for communicating with the reward programme participants and the reward programme provider.

21. A method of maintaining a database for intermediating in transactions of reward points involving at least one reward programme participant and at least one reward programme provider, the database comprising:
maintaining a structured data record that records reward points held by the reward programme participants with the reward programme provider;
creating a structured data record of reward points that are issued to the reward programme participants for cash or like consideration received from reward programme participants;
creating a structured data record of reward points held by the reward programme participants that are cancelled for cash or like consideration provided to the reward programme participants; and
updating the structured data record that records reward points in response to accepted requests to cancel or issue reward points that are recognized by the reward programme provider.

22. A database system for intermediating in transactions of reward points involving at least one reward programme participant and at least one reward programme provider, the database system comprising:
a structured data record of reward points held by reward programme participants with the reward programme provider;
a structured data record of reward points that are issued to the reward programme participants for cash or like consideration received from the reward programme provider;
a structured data record of reward points held by the reward programme participants that are cancelled for cash or like consideration provided to the reward programme participants; and
computer software modules for updating the structured data record of reward points in response to an accepted request to cancel or issue reward points that are recognized by the reward programme provider.

23. A computer program product for intermediating in transactions of reward points involving at least one reward programme participant and at least one reward programme provider, the computer program product comprising software code for performing the following steps:
accessing a structured data record of reward points held by the reward programme participants with the reward programme provider;
creating a structured data record of reward points that are issued to the reward programme participants for cash or like consideration received from the reward programme participants; and
creating a structured data record of reward points held by the reward programme participants that are cancelled for cash or like consideration provided to the reward programme participants.
